(19) United States
(12) Patent Application Publication
(10) Pub. No.: US 2006/0262253 A1
(43) Pub. Date: Nov. 23, 2006

(54) Liquid crystal display device

(76) Inventors: Kenichiro Teramoto, Nomi-shi (JP); Masanobu Nonaka, Ibo-gun (JP); Tatsuya Wakimoto, Ibo-gun (JP); Motoyuki Kitabata, Aioi-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/431,717

(22) Filed: May 11, 2006

(30) Foreign Application Priority Data
May 13, 2005 (JP) 2005-141054
Apr. 26, 2006 (JP) 2006-122524

(51) Int. Cl. G02F 1/1333

(52) U.S. Cl. 349/110

(57) ABSTRACT

A liquid crystal display device includes a transmissive liquid crystal display panel which is disposed on a front side of a display medium that is capable of effecting variable display, and a pair of polarizer plates which are disposed on outer surfaces of the liquid crystal display panel. The liquid crystal display panel includes an image display section which is configured to be capable displaying an image, a substantially rectangular transmissive display section which corresponds to a region where the display medium is disposed, and a light shield section which is disposed between the image display section and the transmissive display section. Each of the polarizer plates includes a substantially rectangular aperture corresponding to the region where the display medium is disposed, and an edge which defines the aperture is positioned on the light shield section of the liquid crystal display panel.

### CROSS-REFERENCE TO RELATED APPLICATIONS

This application is based upon and claims the benefit of priority from prior Japanese Patent Applications No. 2005-141054, filed May 13, 2005; and No. 2006-122524, filed Apr. 26, 2006, the entire contents of both of which are incorporated herein by reference.

### BACKGROUND OF THE INVENTION

1. Field of the Invention

The present invention relates generally to a liquid crystal display device, and more particularly to a liquid crystal display device including a transmissive liquid crystal display panel and an area light source device that illuminates the transmissive liquid crystal display panel.

2. Description of the Related Art

Liquid crystal display devices have been applied to various fields as display devices for OA equipment and information terminal devices such as personal computers, taking advantage of their features of light weight, small thickness and low power consumption. In recent years, the liquid crystal display devices have also been applied to game machines such as slot machines. A liquid crystal display panel, which is mounted on a game machine, is, for example, fitted on the front surface of the casing of the game machine.

Specifically, a central part of the liquid crystal display panel is provided with a transmissive section that makes it possible to view from outside a lottery result that is based on pictures on a display medium such as a rotary reel, which is contained in the casing of the game machine. This liquid crystal display panel has basically the same structure as a liquid crystal display panel for ordinary uses. However, in the transmissive section, a spacer having the same thickness as a color filter, which is disposed in an image display section, is disposed in place of the color filter. In addition, polarizer plates are disposed on the entire outer surfaces of a pair of substrates that constitute the liquid crystal display panel (see, for instance, Jpn. Pat. Appln. KOKAI Publication No. 2004-8705).

As regards the game machine with the above-described structure, there has been a demand for the improvement in visibility of the display medium through the transmissive section. As described in Patent Document 1, the display medium is viewed through a liquid crystal display panel and a pair of polarizer plates. Consequently, the visibility of the display medium is affected by the transmittance of the liquid crystal display panel and the pair of polarizer plates.

### BRIEF SUMMARY OF THE INVENTION

The present invention has been made in consideration of the above-described problem, and the object of the invention is to provide a liquid crystal display device capable of improving visibility of a display medium that is disposed behind a liquid crystal display panel.

According to an aspect of the present invention, there is provided a liquid crystal display device comprising: a transmissive liquid crystal display panel which is disposed on a front side of a display medium that is capable of effecting variable display; and a pair of polarizer plates which are disposed on outer surfaces of the liquid crystal display panel, wherein the liquid crystal display panel includes an image display section which is configured to be capable displaying an image and includes a plurality of matrix-arrayed display pixels, a substantially rectangular transmissive display section which corresponds to a region where the display medium is disposed, and a frame-shaped light shield section which is disposed between the image display section and the transmissive display section, and each of the polarizer plates includes a substantially rectangular aperture corresponding to the region where the display medium is disposed, and an edge which defines the aperture is positioned on the light shield section of the liquid crystal display panel.

The present invention can provide a liquid crystal display device capable of improving visibility of a display medium that is disposed behind a liquid crystal display panel.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an exploded perspective view that schematically shows the structure of a liquid crystal display device according to an embodiment of the present invention;

FIG. 2 is a cross-sectional view that schematically shows the structure of a liquid crystal display panel which is applicable to the liquid crystal display device shown in FIG. 1;

FIG. 3 is an exploded perspective view that schematically shows the structure of an area light source device that is mounted on the liquid crystal display device shown in FIG. 1;

FIG. 4 is a cross-sectional view that schematically shows the structure of a liquid crystal display device which is applied to a game machine;

FIG. 5 is a view for explaining a positional relationship between a light shield section of the liquid crystal display panel and apertures in polarizer plates, which are shown in FIG. 2;

FIG. 6 is a view for explaining another positional relationship between the light shield section of the liquid crystal display panel and the apertures in polarizer plates, which are shown in FIG. 2; and

FIG. 7 is a cross-sectional view that schematically shows the structure of another liquid crystal display panel which is applicable to the liquid crystal display device shown in FIG. 1.

### DETAILED DESCRIPTION OF THE INVENTION

A liquid crystal display device according to an embodiment of the present invention, in particular, a liquid crystal display device that is applicable to a game machine, will now be described with reference to the accompanying drawings.

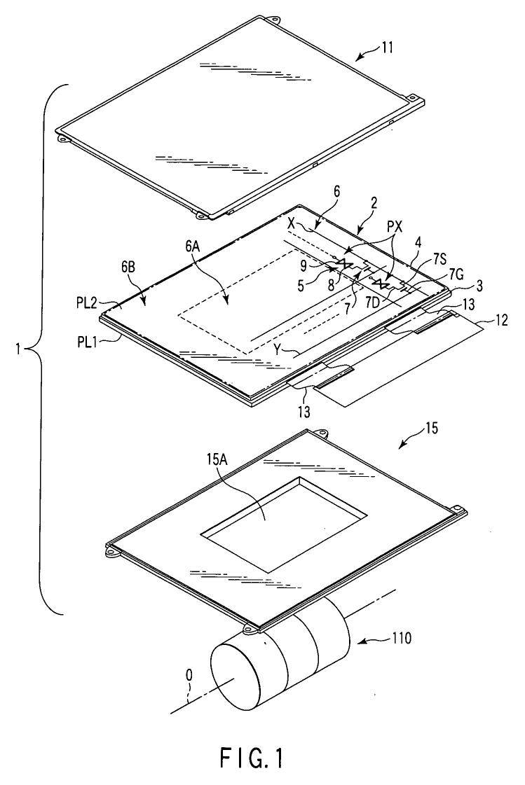

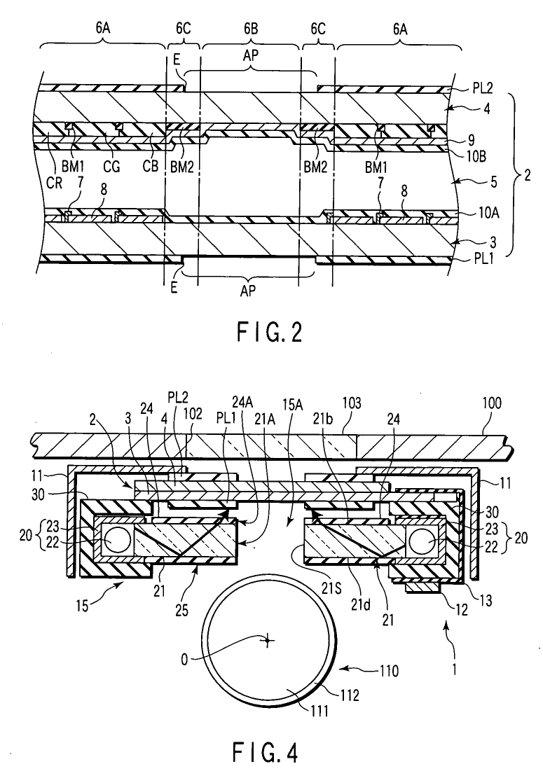

As is shown in FIG. 1 and FIG. 2, a liquid crystal display device 1 includes a substantially rectangular, planar transmissive liquid crystal display panel 2. The liquid crystal display panel 2 is configured such that a liquid crystal layer 5 that serves as an optical modulation layer is interposed between a pair of substrates, that is, an array substrate 3 and a counter-substrate 4. The liquid crystal display panel 2 includes a substantially rectangular effective section 6 that displays an image. The effective section 6 is composed of a plurality of display pixels PX that are arrayed in a matrix. In addition, the effective section 6 includes an image display section 6A which is configured to mainly display an image, and a substantially rectangular transmissive display section 6B which makes a display medium (to be described later) visible.

The array substrate 3 includes, in the effective section 6, a plurality of scan lines Y that extend in a row direction of the display pixels PX, a plurality of signal lines X that extend in a column direction of the display pixels PX, switching elements 7 that are arranged near intersections between scan lines Y and signal lines X in association with the respective display pixels PX, and pixel electrodes 8 that are connected to the switching elements 7.

The switching element 7 is formed of, e.g. a thin-film transistor (TFT). The switching element 7 has a gate electrode 7G that is electrically connected to the associated scan line Y (or formed integral with the scan line). The switching element 7 has a source electrode 7S that is electrically connected to the associated signal line X (or formed integral with the signal line). The switching element 7 has a drain electrode 7D that is electrically connected to the pixel electrode 8 of the associated display pixel PX.

The counter-substrate 4 includes, in the effective section 6, a counter-electrode 9 that is common to all the display pixels PX. The pixel electrodes 8 and counter-electrode 9 are formed of an electrically conductive material with light transmissivity such as ITO (indium tin oxide).

The array substrate 3 and counter-substrate 4 have alignment films 10A and 10B on their inner surfaces (i.e. a surface of the array substrate 3, on which the pixel electrodes 8 are disposed, and a surface of the counter-substrate 4, on which the counter-electrode 9 is disposed). The array substrate 3 and counter-substrate 4 are disposed such that the alignment films 10A and 10B are opposed to each other, and a gap is formed between array substrate 3 and counter-substrate 4. The liquid crystal layer 5 is formed of a liquid crystal composition that is sealed in the gap between the array substrate 3 and counter-substrate 4.

In the liquid crystal display panel 2, a pair of polarizer plates PL1 and PL2, whose directions of polarization are set in accordance with the characteristics of the liquid crystal layer 5, are provided on the outer surface of the array substrate 3 and the outer surface of the counter-substrate 4.

In a color-display type liquid crystal display device, the liquid crystal display panel 2 includes a plurality of kinds of display pixels, for instance, a red pixel that displays red (R), a green pixel that displays green (G), and a blue pixel that displays blue (B). The liquid crystal display panel 2 shown in FIG. 2 includes, on the inner surface of the counter-substrate 4, a red color filter CR that passes light with a principal wavelength of red in association with the red pixel, a green color filter CG that passes light with a principal wavelength of green in association with the green pixel, and a blue color filter that passes light with a principal wavelength of blue in association with the blue pixel.

The liquid crystal display panel 2 with the above-described structure is disposed between a bezel cover 11 having a rectangular frame-like shape and an area light source device 15. Specifically, the area light source device 15, together with the liquid crystal display panel 2, is formed integral with the bezel cover 11 in the state in which the upper surface of the area light source device 15 is opposed to the back surface (array substrate-side surface) of the liquid crystal display panel 2. The area light source device 15 illuminates the liquid crystal display panel 2 from the back side thereof.

A driver circuit 12, which supplies a drive signal to the liquid crystal display panel 2, is electrically connected to one side edge of the liquid crystal display panel 2 via a flexible printed circuit board 13. The driver circuit 12 is disposed on the back side of the area light source device 15 by bending the printed circuit board 13.

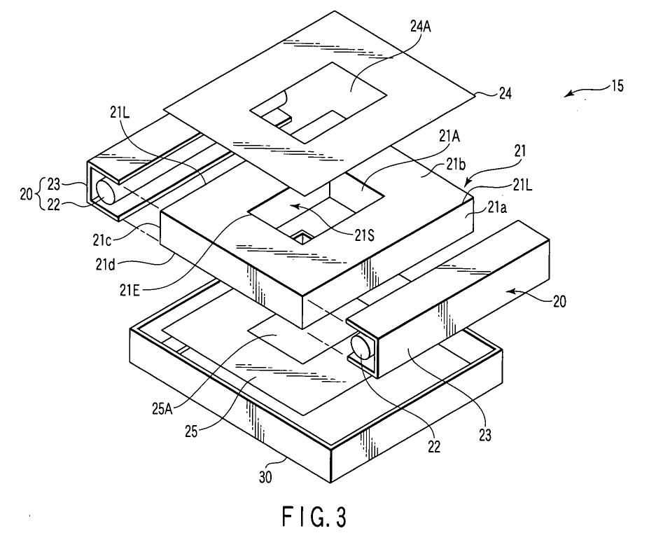

As is shown in FIG. 3, the area light source device 15 includes a light source unit 20 and a light guide 21. The light source unit 20 includes a cold-cathode fluorescent lamp 22 functioning as a light source and a lamp reflector 23. Specifically, the cold-cathode fluorescent lamp 22 is an elongated cylindrical tubular light source that extends in the longitudinal direction of the substantially rectangular light guide 21. The lamp reflector 23 reflects emission light, which comes from the cold-cathode fluorescent lamp 22, toward the light guide 21. The lamp reflector 23 is disposed so as to surround the cold-cathode fluorescent lamp 22.

The light guide 21 is formed of a light transmissive resin material such as an acrylic resin or a polycarbonate resin. The light guide 21 is formed in a substantially rectangular shape and has a substantially uniform thickness as a whole. The light guide 21 has a first major surface 21b that faces the liquid crystal display panel 2, a second major surface 21d that is opposed to the first major surface 21b, and a first side surface 21a and a second side surface 21c that connect the first major surface 21b and second major surface 21d.

In this embodiment, the light source unit 20 is disposed along each of a pair of long sides 21L of the light guide 21. Specifically, the cold-cathode fluorescent lamps 22 are disposed to be substantially parallel to the first side surface 21a and second side surface 21c along the long sides 21L of the light guide 21. To be more specific, the first side surface 21a and second side surface 21c of the light guide 21 correspond to light incidence surfaces, on which emission light from the cold-cathode fluorescent lamp 22 is incident.

The light guide 21 with the above structure is capable of propagating emission light, which has been made incident from the cold-cathode fluorescent lamps 22 through the first side surface 21a and second side surface 21c, and is capable of emitting the propagated light from the first major surface 21b and second major surface 21d. The first major surface 21b and second major surface 21d of the light guide 21 correspond to light emission surfaces for emitting the light that has entered the light guide 21.

A substantially rectangular optical sheet 24 is disposed so as to cover the first major surface 21b of the light guide 21. The optical sheet 24 imparts predetermined optical characteristics to the emission light from the first major surface 21b of the light guide 21. The optical sheet 24 is, for instance, a light converging sheet that converges emission light from the first major surface 21b, a diffusion sheet that diffuses emission light from the first major surface 21b.

A substantially rectangular optical sheet 25 is disposed so as to cover the second major surface 21d of the light guide 21. The optical sheet 25 is a reflection sheet that reflects emission light, which emerges from the second major surface 21d of the light guide 21, back to the light guide 21. The light source unit 20, light guide 21 and optical sheets 24 and 25 are accommodated in a substantially rectangular frame 30.

The liquid crystal display device with the above-described structure operates as follows. Electric energy is supplied to the cold-cathode fluorescent lamps 22 of the paired light source units 20, thereby turning on the cold-cathode fluorescent lamps 22. Emission lights from the cold-cathode fluorescent lamps 22 are reflected by the inner surfaces of the lamp reflectors 23 that cover the cold-cathode fluorescent lamps 22, and are made to travel toward the first side surface 21a and second side surface 21c of the light guide 21. The incident light that has entered the light guide 21 through its first side surface 21a and second side surface 21c propagates within the light guide 21 and is refracted or reflected toward the first major surface 21b and second major surface 21d of the light guide 21. The emission light emerging from the second major surface 21d of the light guide 21 is reflected back into the light guide 21 by the optical sheet 25.

While the emission light from the first major surface 21b of the light guide 21 is passing through the optical sheet 24, the light is given predetermined optical characteristics. For example, the light is properly converged or diffused. Thereby, the luminance of the emission light from the first major surface 21b of the light guide 21 is enhanced and made uniform.

Illumination light from the area light source device 15, that is, light emerging from the optical sheet 24, is led to the back surface (array substrate-side surface) of the liquid crystal display panel 2. The illumination light that is led to the liquid crystal display panel 2 selectively passes through the effective section 6 of the liquid crystal display panel 2. Thereby, an image is displayed on the effective section 6 of the liquid crystal display panel 2.

Next, a description is given of a liquid crystal display device 1 that is used for a game machine such as slot machine. As is shown in FIG. 1 and FIG. 4, the game machine includes a mechanical rotary reel 110 that is rotatably disposed within a casing 100 as a display medium for effecting variable display. The rotary reel 110 comprises a plurality (e.g. three) cylindrical reel bodies 111 that are rotatable about a rotational axis O, and strip-like reel tapes 112 that are attached to the cylindrical surfaces of the reel bodies 111. The reel tape 112 has a plurality of pictures that are arranged at equal intervals. The reel bodies 111 are arranged in a direction of the rotational axis O.

The liquid crystal display device 1 is disposed on the front side (i.e. viewer's side) of the rotary reel 110 within the casing 100. Specifically, the liquid crystal display panel 2 is disposed on the front side of the rotary reel 110, and the area light source device 15 is disposed between the liquid crystal display panel 2 and the rotary reel 110. The casing 100 has a window section 102 that permits viewing of an image that is displayed on the liquid crystal display device 1. The window section 102 is equipped with a light-transmissive protection plate 103 such as a glass plate.

The area light source device 15, which is mounted on the liquid crystal display device 1, includes an opening part 15A in its substantially central part in such a manner that the position of the opening part 15A corresponds to the position of the rotary reel 110. Specifically, the light guide 21 has an opening part 21A which is opposed to the rotary reel 110. Similarly, the optical sheet 24 has an opening part 24A corresponding to the opening part 21A, and the optical sheet 25 has an opening part 25A corresponding to the opening part 21A. The opening part 15A of the area light source device 15 is substantially rectangular, and a predetermined number of pictures on the rotary reel 110, which is disposed on the back side of the area light source device 15, are made visible.

Thereby, the weight of the light guide 21 is reduced, and accordingly the weight of the liquid crystal display device 1 can be reduced. Since the rotary reel 110 is visible without intervention of the area light source device 15, the visibility of the rotary reel 110 can be enhanced.

In the liquid crystal display panel 2, as described above, the effective section 6 includes the image display section 6A and the transmissive display section 6B. The image display section 6A includes first light shield layers BM1 which function as a black matrix between the matrix-arrayed display pixels PX. The color-display type liquid crystal display panel 2 according to the example shown in FIG. 2 includes the color filter layers C (R, G, B) which are arranged in association with the matrix-arrayed display pixels PX.

On the other hand, the transmissive display section 6B is formed in a substantially rectangular shape corresponding to the region where the rotary reel 110 is disposed. Even in the color-display type liquid crystal display panel 2 according to the example shown in FIG. 2, the transmissive display section 6B has nether a light shield layer or a color filter layer.

The liquid crystal display panel 2 with the above-described structure includes a light shield section 6C between the image display section 6A and transmissive display section 6B in the effective section 6. The light shield section 6C includes a second light shield layer BM2 which is disposed in a frame-like shape between the image display section 6A and transmissive display section 6B so as to surround the rectangular transmissive display section 6B. In the example shown in FIG. 2, the transmissive display section 6B and light shield section 6C include the counter-electrode 9 and alignment film 10B. However, the transmissive display section 6B and light shield section 6C may not necessarily include the counter-electrode 9 and alignment film 10B since no image is displayed in this region.

The pair of polarizer plates PL1 and PL2, which are provided on the outer surfaces of the liquid crystal display panel 2 (i.e. the outer surface of the array substrate 3 and the outer surface of the counter-substrate 4), have substantially rectangular apertures AP at a position corresponding to the region where the rotary reel 110 is disposed. Thus, the rotary reel 110 is visually recognized through only the protection plate 103 and liquid crystal display panel 2. The visibility of the rotary reel 110 is neither affected by the light shield layer and color filter layer in the liquid crystal display panel 2, nor affected by the transmittance of the paired polarizer plates PL1 and PL2. Therefore, the visibility of the rotary reel 110 can further be enhanced.

The polarizer plates PL1 and PL2 are attached to the outer surfaces of the liquid crystal display panel 2 via an adhesive. In some cases, burrs are produced at edges E that define the apertures AP, or the polarizer plates PL1 and PL2 are partly peeled due to defective attachment, resulting in degradation in appearance of display. In particular, if the edges E overlap the image display section 6A or transmissive display section 6B, the problem of degradation in appearance of display tends to occur due to a high brightness on the background.

Taking this into account, in the present embodiment, the paired polarizer plates PL1 and PL2 are disposed such that the edges E defining the apertures AP are positioned on the light shield section 6C of the liquid crystal display panel 2.

Specifically, as shown in FIG. 5, a width W of the light shield section 6C (i.e. width of the second light shield layer BM2) corresponds to a distance between the image display section 6A and transmissive display section 6B, and is set at, e.g. 3 mm. The size of the aperture AP of each of the polarizer plates PL1 and PL2 is greater than the size of the region surrounded by an inner edge Ein of the light shield section 6C (i.e. the edge of the transmissive display section 6B) and is less than the size of the region surrounded by an outer edge Eout of the light shield section 6C (i.e. the edge of the image display section 6A). Accordingly, the edge E that defines the aperture AP entirely overlaps the light shield section 6C. The size, in this context, refers to the lengths of the long side and short side of the substantially rectangular aperture or region.

Thereby, even if burrs are produced at the edges E or the polarizer plates are partly peeled in the vicinity of the edges E, the edges E overlap the light shield section 6C. Thus, the background becomes black and the degradation in appearance of display can be prevented. The width of the light shield section 6C is increased to a certain degree in consideration of the precision of attachment of the polarizer plates PL1 and PL2 to the liquid crystal display panel 2. Even if the position of attachment of the polarizer plates PL1 and PL2 to the liquid crystal display panel 2 is slightly displaced, the edges E can be overlapped with the light shield section 6C and the degradation in appearance of display can be prevented.

Besides, the transmissive display section 6B does not include the color filter or light shield layer. Thus, even if defective display occurs in the vicinity of the image display section 6A due to non-uniformity in gap of the liquid crystal layer or non-uniformity in alignment of liquid crystal molecules, such a problem can be solved since light shield can be effected by the light shield section 6C that is provided between the image display section 6A and transmissive display section 6B.

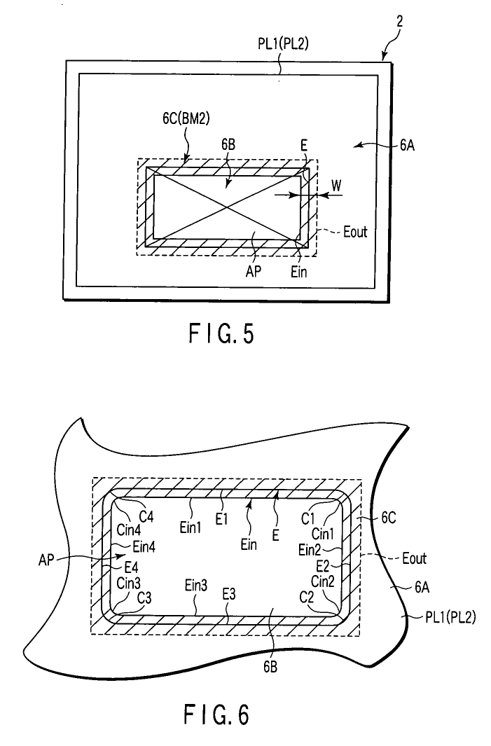

In the above-described embodiment, the inner edge Ein of the light shield section 6C is formed in the substantially rectangular shape. However, the shape of the inner edge Ein is not limited to this example. As shown in FIG. 6, for instance, the inner edge Ein may have such a shape that neighboring two straight portions are connected by an arcuate portion.

If rectangular apertures AP with angular corners are to be formed in the polarizer plates PL1 and PL2 with high precision, the manufacturing cost would increase and the manufacturing yield would decrease. If a sufficient machining precision is not obtained, burrs or the like may be produced near the corners of the formed apertures AP.

As shown in FIG. 6, an aperture AP having an edge E with no angular corners may be formed in the polarizer plate PL1, PL2. In the example shown in FIG. 6, the edge E includes four straight portions E1, E2, E3 and E4 which are arranged on the four sides, an arcuate portion C1 which connects the straight portions E1 and E2, an arcuate portion C2 which connects the straight portions E2 and E3, an arcuate portion C3 which connects the straight portions E3 and E4, and an arcuate portion C4 which connects the straight portions E1 and E4. The center of curvature of each of the arcuate portions C1, C2, C3 and C4 is located within the aperture AP. In other words, each arcuate portion is curved outward of the aperture AP. Thus, the arcuate portions and straight portions are connected without angular corners. In order to form the aperture AP with this shape, there is no need to form angular corners with high precision. Therefore, the increase in manufacturing cost and the decrease in manufacturing yield can be suppressed.

On the other hand, in accordance with the shape of the polarizer plate PL1, PL2 having the aperture AP with the above-described shape, at least the inner edge Ein of the light shield section 6C includes four straight portions Ein1, Ein2, Ein3 and Ein4 which are arranged on the four sides, an arcuate portion Cin1 which connects the straight portions Ein1 and Ein2, an arcuate portion Cin2 which connects the straight portions Ein2 and Ein3, an arcuate portion Cin3 which connects the straight portions Ein3 and Ein4, and an arcuate portion Cin4 which connects the straight portions Ein1 and Ein4. The center of curvature of each of the arcuate portions Cin1, Cin2, Cin3 and Cin4 is located within the region surrounded by the inner edge Ein. Thus, the arcuate portions and straight portions are connected without angular corners. Therefore, high machining precision is not required, and the degradation in appearance of display can be prevented.

In the liquid crystal display panel 2 having the structure shown in FIG. 2, the second light shield layer BM2, which is disposed in the light shield section 6C, may be formed of the same material as the first light shield layer BM1 which is disposed in the image display section 6A. In short, the first light shield layer BM1 and the second light shield layer BM2 can be formed in the same manufacturing step, and no increase is caused in the number of manufacturing steps or in the manufacturing cost.

The second light shield layer BM2, which is disposed in the light shield section 6C, is so formed as to have the width W (e.g. on the order of mm) in consideration of the precision of attachment of the polarizer plates PL1 and PL2. On the other hand, the first light shield layer BM1, which is disposed in the image display section 6A, is formed (e.g. on the order of μm) so as to shield light between the display pixels PX. Thus, the second light shield layer BM2 is formed to have a greater width than the first light shield layer BM1.

As has been described above, according to the liquid crystal display device of the embodiment that is applicable to the game machine, the light guide of the area light source device has the opening part corresponding to the position where the rotary reel, which is the display medium, is disposed. Thereby, the weight of the light guide is reduced and the weight of the liquid crystal display device can be reduced. The polarizer plates have the apertures corresponding to the position of the rotary reel. Thus, the rotary reel is made visible through the transmissive display section of the liquid crystal display panel, which does not have the color filter layer or light shield layer, without intervention of the area light source device and polarizer plates. Therefore, the visibility of the rotary reel can be enhanced.

The polarizer plate is disposed such that the edge, which defines its aperture, overlaps the light shield section of the liquid crystal display panel. Thus, even if burrs are produced or peeling occurs near the edge of the polarizer plate, such burrs or the like would not become conspicuous since the background is black. Therefore, the degradation in appearance of display can be prevented.

The present invention is not limited to the above-described embodiment. In practice, the structural elements can be modified without departing from the spirit of the invention. Various inventions can be made by properly combining the structural elements disclosed in the embodiment. For example, some structural elements may be omitted from all the structural elements disclosed in the embodiment. Furthermore, structural elements in different embodiments may properly be combined.

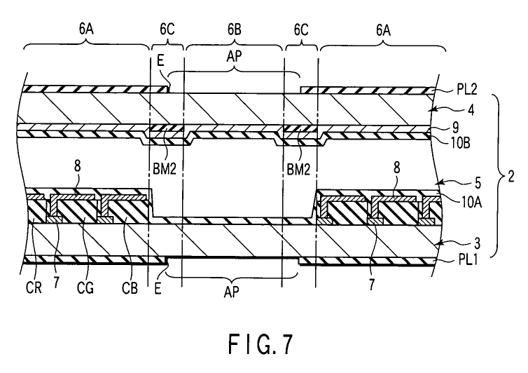

For example, as shown in FIG. 7, the liquid crystal display panel 2 may be configured to include color filters C (R, G, B) which are disposed on the array substrate 3. In the so-called color-filter-on-array configuration, the scan lines and signal lines, which are formed of a metallic material with light shield properties, function as the black matrix (first light shield layer). On the other hand, the second light shield layer BM2, which is disposed in the light shield section 6C, is provided on the counter-substrate 4, as in the example of the structure shown in FIG. 2. In the example shown in FIG. 7, none of the switching element, pixel electrode and color filter is disposed in the transmissive display section 6B and light shield section 6C. However, like the image display section 6A, the switching element may be disposed. In addition, the color filter layer may be replaced with a transparent resin layer, and the pixel electrode may be disposed on the transparent resin layer.

With this structure, too, neither the color filter layer nor the light shield layer may be disposed in the transmissive display section 6B, and the apertures AP may be formed in the polarizer plates PL1 and PL2. Thereby, the visibility of the rotary reel that is the display medium can be enhanced. In addition, by disposing the polarizer plates such that the edges E defining the apertures AP overlap the light shield section 6C, the degradation in appearance of display can be improved.

What is claimed is:

1. A liquid crystal display device comprising:
a transmissive liquid crystal display panel which is disposed on a front side of a display medium that is capable of effecting variable display; and
a pair of polarizer plates which are disposed on outer surfaces of the liquid crystal display panel,
wherein the liquid crystal display panel includes an image display section which is configured to be capable displaying an image and includes a plurality of matrix-arrayed display pixels, a substantially rectangular transmissive display section which corresponds to a region where the display medium is disposed, and a frame-shaped light shield section which is disposed between the image display section and the transmissive display section, and
each of the polarizer plates includes a substantially rectangular aperture corresponding to the region where the display medium is disposed, and an edge which defines the aperture is positioned on the light shield section of the liquid crystal display panel.

2. The liquid crystal display device according to claim 1, wherein an inner edge of the light shield section has such a shape that neighboring two straight portions are connected by an arcuate portion.

3. The liquid crystal display device according to claim 1, wherein the image display section includes a first light shield layer which is disposed between the display pixels, and the light shield section includes a second light shield layer which is formed of the same material as the first light shield layer.

4. The liquid crystal display device according to claim 3, wherein the second light shield layer is formed to have a greater width than the first light shield layer.

5. The liquid crystal display device according to claim 1, wherein the image display section includes a color filter layer which is disposed in association with the matrix-arrayed display pixels.

6. The liquid crystal display device according to claim 1, wherein the transmissive display section includes neither a color filter layer nor a light shield layer.

7. The liquid crystal display device according to claim 1, further comprising an area light source device which is disposed between the liquid crystal display panel and the display medium and illuminates the liquid crystal display panel from a back side thereof, the area light source device including:
a light source;
a light guide which includes an opening part that is opposed to the display medium, and emits radiation light from the light source toward the liquid crystal display panel; and
an optical sheet which imparts predetermined optical characteristics to the light emitted from the light guide.

8. The liquid crystal display device according to claim 5, wherein the liquid crystal display panel is composed of an array substrate having pixel electrodes associated with the display pixels, a counter-substrate having a counter-electrode which is common to the display pixels, and a liquid crystal layer which is held between the array substrate and the counter-substrate, and
the color filter layer is disposed on the array substrate.

9. The liquid crystal display device according to claim 5, wherein the liquid crystal display panel is composed of an array substrate having pixel electrodes associated with the display pixels, a counter-substrate having a counter-electrode which is common to the display pixels, and a liquid crystal layer which is held between the array substrate and the counter-substrate, and
the color filter layer is disposed on the counter-substrate.
